(19) United States
(12) Patent Application Publication
(10) Pub. No.: US 2003/0206791 A1
(43) Pub. Date: Nov. 6, 2003

(54) Elevator delivery system for use in truck body or trailer

(76) Inventor: Ronald Paul Wroblewski, Epsom, NH (US)

Correspondence Address: DEVINE, MILLIMET & BRANCH, P.A., 111 AMHERST STREET, BOX 719, MANCHESTER, NH, 03105, US

(21) Appl. No.: 10/351,812

(22) Filed: Jan. 27, 2003

Related U.S. Application Data
(60) Provisional application No. 60/376,694, filed on May 1, 2002.

(51) Int. Cl. B60P 1/00

(52) U.S. Cl. 414/545

(57) ABSTRACT

An elevator delivery system is used with a truck body or trailer to facilitate loading and unloading cargo. The elevator delivery system includes a platform and drive mechanism for raising and lowering the platform. A control system and various types of switches allow the operator to control the raising and lowering of the platform.

### CROSS-REFERENCE TO RELATED APPLICATIONS

This application claims the benefit of U.S. provisional application Serial No. 60/376,694 filed May 1, 2002, which is fully incorporated herein by reference.

### TECHNICAL FIELD

The present invention relates to loading and unloading cargo in a truck or trailer and more particularly, to an elevator delivery system for use in a truck body or trailer.

### BACKGROUND INFORMATION

Trucks have long been used to transport large amounts of cargo of various types. The truck bodies and trailers used to hold the cargo are typically designed to have a high clearance from the ground. Although the cargo can often be loaded easily into the truck bodies and trailers at a loading dock, the cargo is more difficult to load and unload from the ground. The drivers often must climb in and out of the truck to unload the cargo during deliveries. The additional labor required to unload the cargo may result in longer delivery times and more injuries to the delivery person.

Various devices have been used to facilitate unloading the cargo, for example, ramps and hydraulic tailgates added to the rear of the truck or trailer chassis. Although these devices may help to unload the cargo, they often take additional time and labor to operate, for example, to pull out the ramp or to unfold the tailgate platform. Another device, known as the Lang doorway lift, uses a platform to lower or lift the cargo from the truck bed usually in a side door of the truck body. The Lang doorway lift, however, is operated using a single hydraulic cylinder and a complicated cable and pulley system. This cable and pulley system is inefficient and may be dangerous to the operator. Therefore, these existing devices for unloading cargo often do not make the delivery easier.

Accordingly, there is a need for an elevator delivery system for use in a truck body or trailer that is relatively easy to operate and that minimizes injuries.

### SUMMARY

In accordance with one aspect of the present invention, an elevator delivery system for use in a truck body comprises a platform, at least two drive mechanisms for moving the platform upward and downward with respect to the truck body, and a control system for controlling the upward and downward movement of the platform. The control system is actuatable by an operator while the operator is standing on the platform. The control system is also actuatable from a location at which the platform is out of reach of the operator.

In accordance with another aspect of the present invention, a combination truck body and elevator delivery system comprises an enclosed truck body having a bed, walls around the bed, and a door coupled to at least one of the walls for covering a doorway. The bed includes a platform region adjacent the doorway. The combination truck body and elevator delivery system further comprises a platform for moving relative to the truck body and into the platform region and at least two hydraulic cylinder/piston mechanisms for moving the platform upward and downward with respect to the truck body. The hydraulic cylinder/piston mechanisms include at least two pistons mounted respectively on opposite sides of the platform and at least two hydraulic cylinders mounted to the truck body. The pistons move within the cylinders to move the platform relative to the truck body. A hydraulic control system supplies hydraulic fluid to the hydraulic cylinders to control the upward and downward movement of the platform.

In accordance with a further aspect of the present invention, an elevator delivery system for use in a truck body comprises a platform and at least two hydraulic cylinder/piston mechanisms for moving the platform upward and downward with respect to the truck body. The hydraulic cylinder/piston mechanisms include at least two pistons mounted respectively on opposite sides of the platform and at least two hydraulic cylinders mounted to the truck body. The pistons move within the cylinders to move the platform relative to the truck body. A hydraulic control system supplies hydraulic fluid to the hydraulic cylinders to control the upward and downward movement of the platform. An edge switch is located around an edge of the truck body adjacent to the platform such that an object caught between the platform and the truck body causes the hydraulic control system to move the platform downward. An inside switch actuates the hydraulic control system from a location inside of the truck body. The inside switch is located such that an operator of the inside switch is able to stand on the platform while the platform moves upward and downward. An outside switch actuates the hydraulic control system from a location outside of the truck body. The outside switch is located such that the platform is away from an operator of the outside switch.

### BRIEF DESCRIPTION OF THE DRAWINGS

These and other features and advantages of the present invention will be better understood by reading the following detailed description, taken together with the drawings wherein:

FIG. 1 is a perspective view of a truck body or trailer with an elevator delivery system, according to one embodiment of the present invention;

FIG. 2 is a sectional perspective view of the elevator delivery system shown in FIG. 1;

FIG. 3 is a top schematic view of one embodiment of the elevator delivery system;

FIG. 4 is a schematic view of one embodiment of the hydraulic control system used in the elevator delivery system; and

FIGS. 5A-5C are rear views of a truck body, according to one embodiment of the present invention, illustrating one method of using the elevator delivery system to unload cargo.

### DETAILED DESCRIPTION OF THE PREFERRED EMBODIMENTS

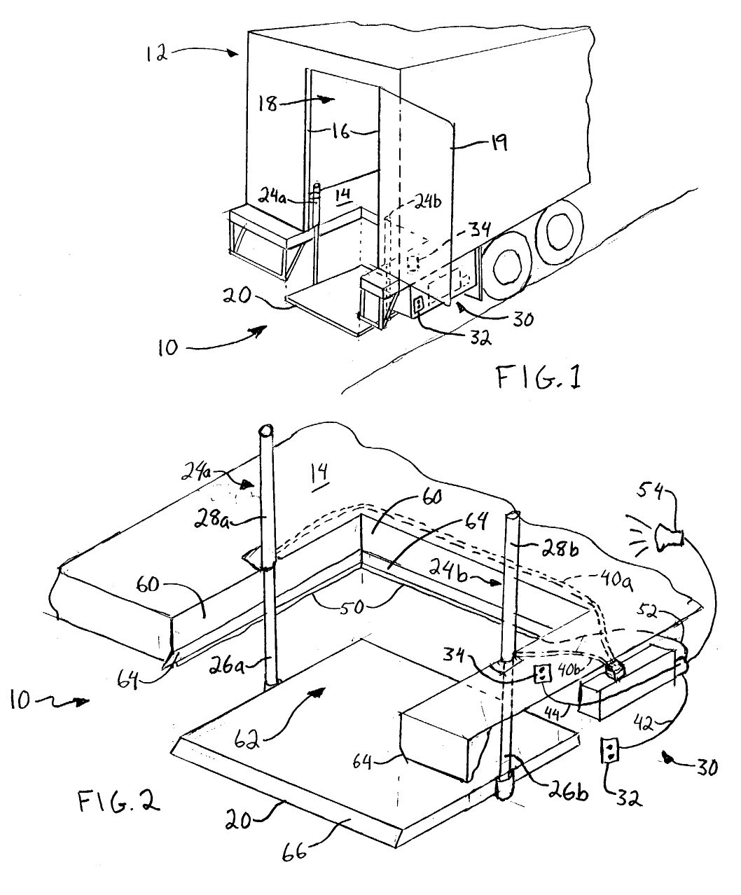

Referring to FIG. 1, an elevator delivery system 10, according to one embodiment of the present invention, is located in a truck body 12 for moving cargo relative to the bed 14 of the truck body 12. As used herein, the term “truck body” refers to both a non-detachable truck body and detachable truck body (e.g., trailer). In the exemplary embodiment, the elevator delivery system 10 is located between the walls 16 forming the rear doorway 18, which is accessible by opening the door 19. A portion of the exemplary elevator delivery system 10 extends beyond the walls 16 outside of the truck body 12. Alternatively, the elevator delivery system 10 can be located at a side doorway or any other suitable location in the truck body 12.

Referring to FIG. 2, the elevator delivery system 10 comprises a platform 20 and at least two hydraulic cylinder/piston mechanisms 24a, 24b. Each of the hydraulic cylinder/piston mechanisms 24a, 24b includes a piston 26a, 26b mounted to the platform 20 and a cylinder 28a, 28b mounted to the truck body 12 such that movement of the pistons 26a, 26b relative to the cylinders 28a, 28b causes movement of the platform 20 relative to the truck body 12. The pistons 26a, 26b and cylinders 28a, 28b can be mounted using any known techniques (e.g., by using plates or other fixtures welded to the platform 20 and the truck body 12). In the exemplary embodiment, the pistons 26a, 26b are mounted at opposite sides of the platform 20. Although the pistons 26a, 26b are shown mounted generally at a midpoint of the platform 20, the pistons 26a, 26b can be mounted in other locations on the platform 20. In the exemplary embodiment, the cylinders 28a, 28b are mounted to the bed 14 of the truck body 12. The cylinders 28a, 28b can also be mounted to other locations, such as to the walls 16 (see FIG. 1) of the truck body 12. In a further embodiment (not shown), the cylinders 28a, 28b can be located within the walls 16 of the truck body 12, thereby hiding the cylinders 28a, 28b and avoiding interference with the cargo.

A hydraulic control system 30, described in greater detail below, controls the supply of fluid to the hydraulic cylinder/piston mechanisms 24a, 24b and thus controls the movement of the platform 20. The hydraulic control system 30 is preferably actuated from both inside and outside the truck body 12. For example, an outside up/down switch 32 is located outside of the truck body 12 to allow the user to raise and/or lower the platform 20 from outside of the truck body 12. The outside switch 32 is preferably in a location that keeps the user away from the platform 20 when it is being lowered. An inside up/down switch 34 is located inside the truck body to allow the user to raise and/or lower the platform 20 from inside the truck body 12, for example, when standing on the platform 20. Although the exemplary embodiment shows the hydraulic control system 30 in a location outside of and below the truck body 12, the hydraulic control system 30 can be located in other locations inside or outside of the truck body 12.

The cylinders 28a, 28b are coupled to the hydraulic control system 30 by way of hydraulic lines 40a, 40b. The hydraulic lines 40a, 40b are preferably in a location that will not interfere with loading and unloading cargo (e.g., under the truck bed 14). The outside switch 32 and the inside switch 34 are connected to the hydraulic control system 30 by way of wires 42, 44, respectively. Other connections between the hydraulic control system 30 and the cylinders 28a, 28b and the switches 32, 34 are also contemplated.

In one preferred embodiment, an edge switch 50 is located around the edge of the underside of the truck body 12 adjacent to the path of the moving platform 20. The edge switch 50 is connected to the hydraulic control system 30 by way of wire 52. The edge switch 50 provides an added safety feature when the platform 20 is being raised. If an object, such as the cargo or the driver's foot, is positioned between the platform 20 and the underside of the truck body 12 when the platform 20 is being raised, the object will actuate the edge switch 50. Actuation of the edge switch 50 causes the hydraulic control system 30 to preferably move the platform 20 downward to avoid damage or injury.

In another preferred embodiment, an audible alarm 54 alerts the operator that the platform 20 is being raised and/or lowered. The audible alarm 54 can be connected to the hydraulic control system 30 and located in any location that permits the alarm to be heard near the elevator delivery system 10.

One embodiment of the truck body 12 preferably includes bracing 60 surrounding the platform region 62, which receives the platform 20 in the raised position. A lower portion 64 of the bracing 60 is preferably tapered such that an object (e.g., the driver's toe) that comes into contact with the tapered lower portion 64 will slide out of the way to avoid damage or injury. In this embodiment, the edge switch 50 is located beneath the tapered lower portion 64 of the bracing 60. A rubber seal (not shown) can be provided along the top portion of the bracing 60 to seal against the platform 20 when raised. One embodiment of the platform 20 includes a ramp surface 66 at one side to allow cargo to be more easily wheeled off of the platform 20.

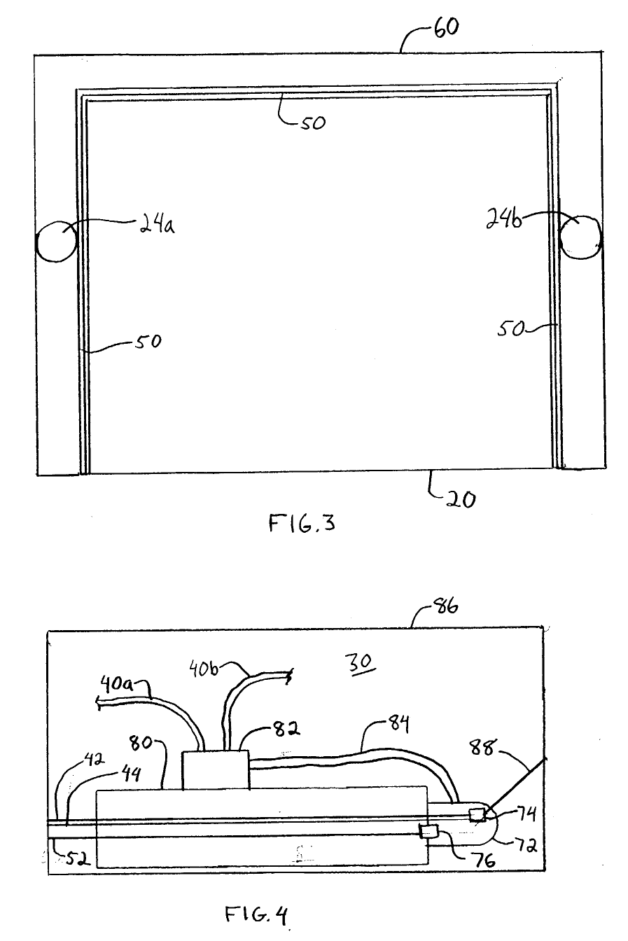

Referring to FIG. 3, an exemplary embodiment of the elevator delivery system 10 is shown schematically. In the exemplary embodiment, the truck body 12 includes 8″ structural steel channels forming the bracing 60. The exemplary hydraulic cylinders 28a, 28b supported on the channels are single acting hydraulic cylinders having a bore of about 2½″ and a length of about 77″. The tapered lower portion 64 of the bracing 60 is a formed as a section having a width of about 5″ flared out at about 45° under the channels. The exemplary platform 20 is made of 1″ steel having a dimension of about 48″ by 44″ and having a 2″ by 2″ bracing.

Referring to FIG. 4, an exemplary embodiment of the hydraulic control system 30 is shown schematically. According to this embodiment, the hydraulic control system 30 includes an electric hydraulic pump 72 with an electric solenoid 74 and a dump valve 76. In one example, the pump 72 is a pump having a rating of about 2500 psi, such as the type available under the name Monarch from Monarch Hydraulics. The wires 42, 44 connect the solenoid 74 to the outside switch 32 and the inside switch 34 (see FIG. 2), respectively, and the wire 52 connects the dump valve 76 to the edge switch 50. The wire 88 connects the electric hydraulic pump 72 to a power source such as the vehicle battery (not shown). The pump 72 is connected to a tank 80 (e.g., a 3 gallon tank) that supplies hydraulic fluid to the pump 72. A flow divider valve 82 is connected to the pump 72 by way of a hydraulic line 84 and connects the pump 72 to the hydraulic lines 40a, 40b from the cylinders 28a, 28b. The hydraulic control system 30 is preferably housed in an enclosure 86 that protects and allows access to the hydraulic control system 30.

In response to signals from the up/down switches 32, 34, the solenoid 74 actuates the pump 72 to pump hydraulic fluid through the lines 40a, 40b to or from the hydraulic cylinders 28a, 28b to lower or raise the platform 20. The flow divider valve 82 evenly distributes the hydraulic fluid pressure between the hydraulic cylinders 28a, 28b to maintain the platform 20 in a substantially level position when a load is being raised or lowered, thereby preventing the hydraulic cylinder/piston mechanisms 24a, 24b from binding. In response to the edge switch 50, the dump valve 76 is actuated causing the platform 20 to drop. In one embodiment, the elevator delivery system 10 at a back door of the truck body is capable of lifting about 2500 lbs. or more and the elevator delivery system 10 at a side door of the truck body is capable of lifting about 1500 lbs. or more, although this is not a limitation of the present invention.

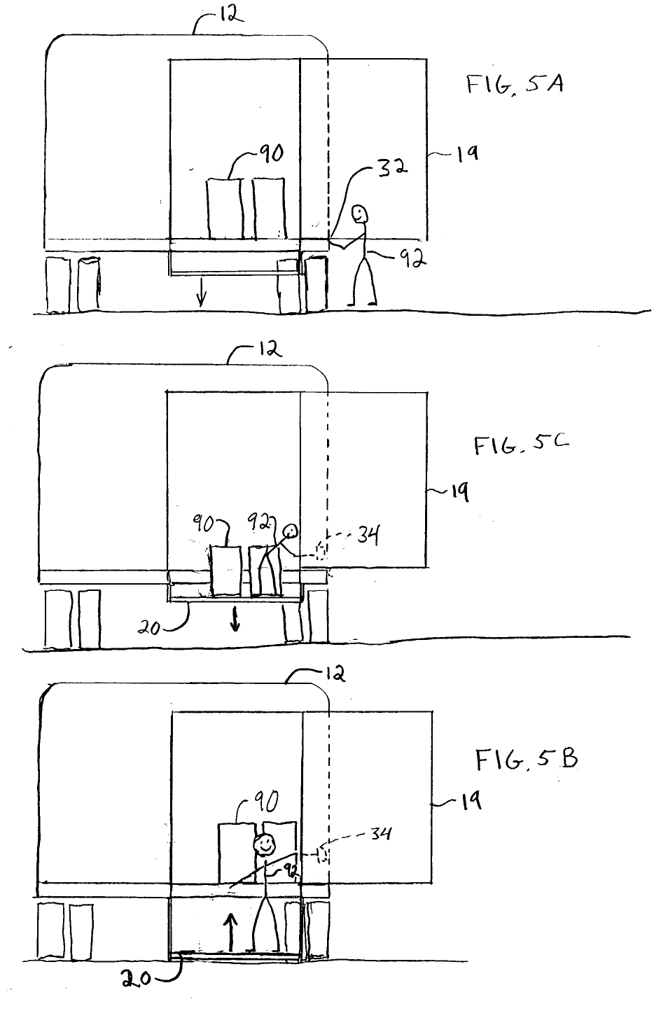

In use, the platform 20 can be raised or lowered using either the outside switch 32 or the inside switch 34. Referring to FIGS. 5A-5C, one method of using the elevator delivery system 10 is described in greater detail. At the beginning of a delivery, the driver 92 can open the door 19 and drop the platform 20, for example, using the outside switch 32 (FIG. 5A). The driver 92 can then ride up on the platform 20 into the truck body 12 (using the inside switch 34) to load the cargo 90 onto the platform 20 (FIG. 5B). When the platform 20 is loaded with the cargo 90, the driver 92 can lower the platform 20 and the cargo 90, for example, using the inside switch 34 (FIG. 5C). This process can be repeated until the delivery is completed. Thus, the driver 92 can use the elevator delivery system 20 to avoid having to climb in and out of the truck when making deliveries.

Accordingly, the elevator delivery system 20 is relatively easy to operate compared to existing devices and thus facilitates the unloading and loading of cargo into a truck or trailer. The elevator delivery system 20 also has fewer moving parts and thus operates more efficiently and reliably than existing hydraulic tailgate and lift devices. The elevator delivery system 20 further provides a number of additional safety features to avoid injury to the operator. For example, the location of the inside switch and the outside switch 32, the edge switch 50, and the audible alarm 54 all provide safety features that will minimize injuries caused by using the elevator delivery system 10.

Modifications and substitutions by one of ordinary skill in the art are considered to be within the scope of the present invention, which is not to be limited except by the following claims.

The invention claimed is:

1. An elevator delivery system for use in a truck body, comprising:
a platform;
at least two drive mechanisms for moving said platform upward and downward with respect to said truck body; and
a control system for controlling the upward and downward movement of said platform, wherein said control system is actuatable by an operator while said operator is standing on said platform, and wherein said control system is actuatable from a location at which said platform is out of reach of said operator.

2. The elevator delivery system of claim 1 wherein said drive mechanisms include at least two pistons mounted respectively on opposite sides of said platform and at least two hydraulic cylinders mounted to said truck body, wherein said pistons move within said cylinders to move said platform relative to said truck body, and wherein said control system supplies hydraulic fluid to said hydraulic cylinders.

3. The elevator delivery system of claim 1 wherein said drive mechanisms include:
two pistons mounted respectively on opposite sides of said platform and generally at a midpoint of said platform; and
two hydraulic cylinders mounted to said truck body, wherein said pistons move within said cylinders to move said platform relative to said truck body.

4. The elevator delivery system of claim 1 further comprising an edge switch located around an edge of said truck body adjacent to said platform such that an object caught between said platform and said truck body causes said control system to move said platform downward.

5. The elevator delivery system of claim 4 wherein said edge switch causes said control system to move said platform downward in response to an object caught between said platform and said truck body.

6. The elevator delivery system of claim 4 further comprising an inside switch for actuating said control system inside of said truck body, wherein said inside switch is located such that an operator of said inside switch is able to stand on said platform while said platform moves upward and downward.

7. The elevator delivery system of claim 6 further comprising an outside switch for actuating said control system outside of said truck body, wherein said outside switch is located such that said platform is away from an operator of said outside switch.

8. The elevator delivery system of claim 1 further comprising an audible alarm for providing a warning when said platform is moved.

9. A combination truck body and elevator delivery system comprising:
an enclosed truck body having a bed, walls around said bed, and a door coupled to at least one of said walls for covering a doorway, wherein said bed includes a platform region adjacent said doorway;
a platform for moving relative to said truck body and into said platform region;
at least two hydraulic cylinder/piston mechanisms for moving said platform upward and downward with respect to said truck body, said hydraulic cylinder/piston mechanisms including at least two pistons mounted respectively on opposite sides of said platform and at least two hydraulic cylinders mounted to said truck body, wherein said pistons move within said cylinders to move said platform relative to said truck body; and
a hydraulic control system for supplying hydraulic fluid to said hydraulic cylinders to control the upward and downward movement of said platform.

10. The system of claim 9 wherein said doorway is in a side wall of said enclosed truck body.

11. The system of claim 9 wherein said doorway is in a rear wall of said enclosed truck body.

12. The system of claim 9 further comprising an inside switch located inside of said truck body for actuating said hydraulic control system from a location inside of said truck body, wherein said inside switch is located such that an operator of said inside switch is able to stand on said platform while said platform moves upward and downward.

13. The system of claim 12 further comprising an outside switch located outside of said truck body for actuating said hydraulic control system from a location outside of said truck body, wherein said outside switch is located such that said platform is away from an operator of said outside switch.

14. The system of claim 9 further comprising an outside switch located outside of said truck body for actuating said hydraulic control system from a location outside of said truck body, wherein said outside switch is located such that said platform is away from an operator of said outside switch.

15. The system of claim 9 further comprising an edge switch located along an edge of said bed around said platform region such that an object caught between said platform and said bed causes said hydraulic control system to move said platform downward.

16. The system of claim 9 further comprising bracing around said platform region, wherein said bracing has a tapered lower portion.

17. The system of claim 9 further comprising an audible alarm for providing a warning when said platform is moved.

18. The system of claim 9 wherein said hydraulic cylinders are hidden inside of said walls of said truck body.

19. The system of claim 9 wherein said hydraulic control system is located outside of said truck body.

20. An elevator delivery system for use in a truck body, comprising:
a platform;
at least two hydraulic cylinder/piston mechanisms for moving said platform upward and downward with respect to said truck body, said hydraulic cylinder/piston mechanisms including at least two pistons mounted respectively on opposite sides of said platform and at least two hydraulic cylinders mounted to said truck body, wherein said pistons move within said cylinders to move said platform relative to said truck body;
a hydraulic control system for supplying hydraulic fluid to said hydraulic cylinders to control the upward and downward movement of said platform;
an edge switch located around an edge of said truck body adjacent to said platform such that an object caught between said platform and said truck body causes said hydraulic control system to move said platform downward;
an inside switch for actuating said hydraulic control system from a location inside of said truck body, wherein said inside switch is located such that an operator of said inside switch is able to stand on said platform while said platform moves upward and downward; and
an outside switch for actuating said hydraulic control system from a location outside of said truck body, wherein said outside switch is located such that said platform is away from an operator of said outside switch.
